(19) United States
(12) Patent Application Publication
(10) Pub. No.: US 2014/0256555 A1
(43) Pub. Date: Sep. 11, 2014

(54) METHODS FOR TREATING FLOWERING PLANTS WITH RIBOSE

(71) Applicant: RiboCor, Inc., Minneapolis, MN (US)

(72) Inventor: Stacey E. Gruett, Elk River, MN (US)

(21) Appl. No.: 14/191,570

(22) Filed: Feb. 27, 2014

Related U.S. Application Data
(60) Provisional application No. 61/775,109, filed on Mar. 8, 2013.
(60) Provisional application No. 61/927,622, filed on Jan. 15, 2014.

(51) Int. Cl. A01N 43/08; C05G 3/00

(52) U.S. Cl. CPC A01N 43/08; C05G 3/00
USPC 504/299

(57) ABSTRACT

Methods for treating a flowering plant are disclosed herein. The methods include watering the flowering plant with a solution comprising D-ribose. In certain embodiments, the blooming of the flowering plant is stimulated.

The present application claims the benefit of U.S. Provisional Application Nos. 61/775,109, filed Mar. 8, 2013, and 61/927,622, filed Jan. 15, 2014, both of which are incorporated herein by reference in their entireties.

### BACKGROUND

Plants undergo periods of physiological stress that may have adverse effects on the plants. Such stress periods may be due to normal events such as flowering where the demand for carbohydrates increases and places a demand on the root system of the plant, causing the roots to be depleted of their normal concentration of carbohydrates. Climate may also play a part in stress. For example, if sunlight is below normal during the growing season and photosynthesis is thereby diminished, the plants may have to draw upon their reserves to sustain flowering, flower setting or fruit setting and maturation. Pathogens such as for example verticillium and fusarium, nematodes, etc. or pests such as mites and aphids may also create stress. For example, verticillium and fusarium tend to plug the vascular tissue of plants, thereby preventing absorption of water and resulting in wilting.

Compositions and methods for stimulating the growth of plants are known. Exemplary such compositions can include an energy component, a micronutrient component, and a macronutrient component. The energy component typically includes a sugar or a mixture of sugars. The micronutrient component typically provides zinc, iron, and manganese, and preferably also copper, boron, molybdenum, and cobalt. The macronutrient component typically provides the elements nitrogen, phosphorus, potassium, and calcium, and preferably also magnesium and sulfur. It has been postulated that the macronutrients are essential to plant nutrition and growth, to flowering, to flower setting, to fruit setting, and to maturation. See, for example, U.S. Pat. No. 6,874,277 (Yamashita).

Compositions including D-ribose have been used in methods for supplementing the soil/diet of plants in order to enhance plant growth, yield, hardening, as well as the recovery of plants which undergo transplantation. D-ribose has been used alone, or in combination with other carbohydrates, electrolytes, minerals, enzymes, micronutrients, macronutrients, or other ingredients to enhance plant growth, yield, hardening, and aid in the recovery during and following transplantation. See, for example, U.S. Patent Application Pub. No. 2003/0217577 A1 (Seifert et al.).

However, there remains a need for methods of improving the blooming of flowering plants.

### SUMMARY

In one aspect, the present disclosure provides a method of treating a flowering plant. In one embodiment, the method includes watering the flowering plant with a solution including 50 mg to 20 grams of D-ribose to one gallon of water.

In another aspect, the present disclosure provides various methods of stimulating blooming of a flowering plant.

In one embodiment, the method of stimulating blooming of the flowering plant includes: selecting a flowering plant under conditions not disposed for blooming; and watering the flowering plant with a solution including D-ribose.

In another embodiment, the method of stimulating blooming of a flowering plant includes: feeding the flowering plant with a plant food; discontinuing feeding the flowering plant with the plant food; and subsequently watering the flowering plant with a solution including D-ribose.

In another embodiment, the method of stimulating blooming of a flowering plant includes: selecting a flowering plant under conditions not disposed for blooming; feeding the flowering plant with a plant food; discontinuing feeding the flowering plant with the plant food; and subsequently watering the flowering plant with a solution including D-ribose.

Advantageously, the methods disclosed herein can be used for treating a flowering plant, and preferably to stimulate the blooming of the flowering plant.

### Definitions

As used herein, the phrase “flowering plant” is intended to mean any plant (including a seedling) that is capable of producing a flower under appropriate conditions.

As used herein, the term “blooming” is intended to mean a flowering plant under conditions wherein the plant is actually producing a flower.

As used herein, the phrase “stimulating blooming” is intended to mean creating conditions wherein a flowering plant is actually producing a flower.

The terms “comprises” and variations thereof do not have a limiting meaning where these terms appear in the description and claims.

As used herein, “a,” “an,” “the,” “at least one,” and “one or more” are used interchangeably.

Also herein, the recitations of numerical ranges by endpoints include all numbers subsumed within that range (e.g., 1 to 5 includes 1, 1.5, 2, 2.75, 3, 3.80, 4, 5, etc.).

The above brief description of various embodiments of the present invention is not intended to describe each embodiment or every implementation of the present invention. Rather, a more complete understanding of the invention will become apparent and appreciated by reference to the following description and claims in view of the accompanying drawings. Further, it is to be understood that other embodiments may be utilized and structural changes may be made without departing from the scope of the present invention.

### DETAILED DESCRIPTION OF ILLUSTRATIVE EMBODIMENTS

The present disclosure provides methods for treating a flowering plant. The methods include watering the flowering plant with a solution comprising D-ribose, either alone or with other ingredients such as plant food ingredients. In certain embodiments, the blooming of the flowering plant is stimulated.

In some embodiments, D-ribose may act as a plant growth regulator (PGR) when used to treat the plant. For example, plant growth regulators such as D-ribose can be applied to plants in commercial bedding plant production to manage growth in a way that enhances specific qualities of the plant. For example, in some embodiments, D-ribose can be used to treat a plant to reduce stem elongation and/or to increase branching. In some embodiments, the application of D-ribose to plants (e.g., flowering plants) can affect elongation, leaf coloration, and time to flower.

In one aspect, the present disclosure provides a method of treating a flowering plant. In one embodiment, the method includes watering the flowering plant with a solution including 50 mg to 20 grams of D-ribose to one gallon of water.

In another aspect, the present disclosure provides a method of stimulating blooming of a flowering plant.

In one embodiment, the method of stimulating blooming of the flowering plant includes: selecting a flowering plant under conditions not disposed for blooming; and watering the flowering plant with a solution including D-ribose.

In another embodiment, the method of stimulating blooming of a flowering plant includes: feeding the flowering plant with a plant food; discontinuing feeding the flowering plant with the plant food; and subsequently watering the flowering plant with a solution including D-ribose.

In another embodiment, the method of stimulating blooming of a flowering plant includes: selecting a flowering plant under conditions not disposed for blooming; feeding the flowering plant with a plant food; discontinuing feeding the flowering plant with the plant food; and subsequently watering the flowering plant with a solution including D-ribose.

### Flowering Plants

Flowering plants are plants that are capable of producing a flower under appropriate conditions. Flowering plants can be annuals or perrenials. Flowering plants can be grown outdoors or indoors. Flowering plants that can be grown outdoors include, for example, ornamental plants and crop plants (e.g., corn, soy beans, etc.), and can be potted or unspotted. Flowering plants that can be grown indoors include, for example, potted plants such as potted house plants.

### Conditions for Blooming

A flowering plant will not necessarily bloom (i.e., actually produce flowers) continuously. For example, many plants only bloom seasonally or periodically. For another example, many plants will not bloom under the local climatic conditions. Also, flowering plants may not bloom when undergoing periods of physiological stress. Such stress periods may be due to normal events such as depletion of carbohydrates in the root system, changes in climate, amount of sunlight, or the presence of pathogens. Such conditions can result in a flowering plant that is not disposed for blooming.

### Plant Food

Plant foods can include various combinations of ingredients including, for example, energy components, micronutrient components, and macronutrient components. Plant foods are available in liquid or solid form, with formulations varying based on the intended use.

An exemplary plant food is available under the trade designation MIRACLE-GRO from The Scotts Company, LLC (Marysville, Ohio). Typical plant food can include exemplary ingredients such as nitrogen sources, phosphate, potash, boron, copper, iron, manganese, molybdenum, zinc, and ethylenediaminetetraacetic acid (EDTA).

### D-Ribose Solution

The methods disclosed herein include water a flowering plant with a solution comprising D-ribose. In some embodiments, the solution can include 50 mg to 20 grams of D-ribose to one gallon of water. In certain embodiments, the solution can include 500 mg to 10 grams of D-ribose to one gallon of water. In other certain embodiments, the solution can include 3 grams to 7 grams of D-ribose to one gallon of water. In some embodiments, the solution can optionally include other ingredients such as plant food ingredients. In some other embodiments, the solution can optionally be substantially free of additional plant food. In certain embodiments, the solution of D-ribose consists of, or consists essentially of, water and D-ribose.

### Application of the D-Ribose Solution

The solution of D-ribose can be applied to the flowering plants continuously or intermittently. When applied intermittently, the solution can be applied using any convenient schedule such as multiple times per day, daily, weekly, twice weekly, monthly, etc. The application of the solution of D-ribose can be continued during part or all of a period for which blooming is desired.

The amount of solution applied over a given period of time can depend on a number of factors including, for example, the type of flowering plant, the growing conditions (e.g., temperature, sunlight, humidity, exposure to wind, etc.), and the moisture content of the growth medium (e.g., soil, bark, compost, or other organic matter). Typically, sufficient solution is applied to result in a moist growth medium.

The solution of D-ribose can be applied to the flowering plants as desired. For example, the solution can be applied to the plant (e.g., the leaves of the plant) or directly to the growth medium in which the plants are growing.

The present invention is illustrated by the following examples. It is to be understood that the particular examples, materials, amounts, and procedures are to be interpreted broadly in accordance with the scope and spirit of the invention as set forth herein.

### EXAMPLES

### Example 1

Plants treated with a solution of D-ribose in this example included Orchids, Christmas Cactus, Palm, Mother's-in-law Tongue/Snake Plant, Rosemary, Bamboo, Pothos, Hibiscus, Jade, Purple Passion, Aloe vera, Schefflera, Cacti, and Norfolk Island Pine.

The use of MIRACLE-GRO liquid plant food was stopped, then the use of a solution of D-ribose to treat the plants was started. Each week a fresh solution of D-ribose was made using 5 grams of D-ribose to one gallon of water.

Sustained blooming in many of the flowering plants as well as unusual types of blooms on traditionally non-blooming plants were observed. Specific observations are noted below. While all the plants were extremely healthy and grew exceptionally well, traditional flowering varieties performed amazingly well. Also two varieties that do not typically bloom in the Minnesota climate, developed blooms.

### Orchids

The first subject was an orchid which had not bloomed in six plus years. Upon treatment with the solution of D-ribose, it sparked two new stems full of blooms. The second subject was another orchid which had not bloomed in three plus years, and it showed the same results as subject one above.

### Christmas Cactus

This variety of plant typically only blooms around the Christmas and Easter holidays each year for a few weeks up to a month or so, then it stops blooming. However, upon treatment with the solution of D-ribose, this plant started to bloom early and sustained an abundance of continued blooms.

### Hibiscus

This plant was taken inside in October for the winter months. Although it bloomed occasionally during the summer, the plant continuously bloomed upon starting treatment with the solution of D-ribose, even being indoors without the humidity and strong sun it typically prefers.

### Palm

This is typically regarded as a non-flowering type of plant. This plant had not bloomed in approximately fifteen years. Upon treatment with the solution of D-ribose, it grew an unusual type of growth that appeared to be a flowering/seed mechanism on two different stems.

### Snake Plant

This is another example of plant typically regarded as a non-flowering type plant. Upon treatment with the solution of D-ribose, it grew unusual growths that appeared to be some type of flowering appendage. It had not bloomed in over 15 years. While flowers on this plant are not unheard of, it is uncommon to bloom in the Minnesota climate and as an indoor plant.

### Purple Waffle

The growth of four plants was observed over a 9 month period. One plant was not fed (control), but watered weekly. One plant was fed MIRACLE-GRO liquid plant food weekly based on product instructions of feeding every time you water by squeezing 10-20 drops into 1 quart of water. One plant was fed 1× (1.5 mg/ml) D-ribose weekly. One plant was fed 2× (3 mg/ml) D-ribose weekly. The length of the stems and the size of the leaves of the MIRACLE-GRO fed plant exhibited enhanced growth compared to the control. In contrast, the length of the stems and size of the leaves of the D-ribose fed plants exhibited similar or less growth than the control. However, the D-ribose fed plants exhibited increased branching compared to both the control and the MIRACLE-GRO fed plant.

The complete disclosure of all patents, patent applications, and publications, and electronically available material (e.g., GenBank amino acid and nucleotide sequence submissions; and protein data bank (pdb) submissions) cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. A method of treating a flowering plant, the method comprising watering the flowering plant with a solution comprising 50 mg to 20 grams of D-ribose to one gallon of water.

2. The method of claim 1 wherein the solution of D-ribose comprises 3 grams to 7 grams of D-ribose to one gallon of water.

3. The method of claim 1 wherein the flowering plant is watered with the D-ribose solution a plurality of times during a period for which blooming is desired.

4. The method of claim 1 wherein the flowering plant is watered with the solution twice per day, daily, weekly, twice weekly, or monthly.

5. The method of claim 1 wherein the flowering plant is watered using sufficient solution to result in a moist growth medium.

6. The method of claim 1 wherein the solution comprising D-ribose is applied to the plants and/or the soil in which the plants are growing.

7. The method of claim 1 wherein the flowering plants are potted plants.

8. The method of claim 7 wherein the flowering plants are potted house plants.

9. The method of claim 1 wherein the flowering plants are selected from the group consisting of Orchids, Christmas Cactus, Palm, Mother's-in-law Tongue/Snake Plant, Rosemary, Bamboo, Pothos, Hibiscus, Jade, Purple Passion, Aloe vera, Schefflera, Cacti, and Norfolk Island Pine.

10. A method of stimulating blooming of a flowering plant, the method comprising:
selecting a flowering plant under conditions not disposed for blooming; and
watering the flowering plant with a solution comprising D-ribose.

11. The method of claim 10 wherein the solution of D-ribose comprises 50 mg to 20 grams of D-ribose to one gallon of water.

12. The method of claim 11 wherein the solution of D-ribose comprises 500 mg to 10 grams of D-ribose to one gallon of water.

13. The method of claim 12 wherein the solution of D-ribose comprises 3 grams to 7 grams of D-ribose to one gallon of water.

14. The method of claim 10 wherein the solution of D-ribose is substantially free of additional plant food.

15. The method of claim 10 wherein the solution of D-ribose consists essentially of water and D-ribose.

16. The method of claim 10 wherein the solution of D-ribose consists of water and D-ribose.

17. A method of stimulating blooming of a flowering plant, the method comprising:
feeding the flowering plant with a plant food;
discontinuing feeding the flowering plant with the plant food; and
subsequently watering the flowering plant with a solution comprising D-ribose.

18. The method of claim 17 wherein the solution of D-ribose comprises 3 grams to 7 grams of D-ribose to one gallon of water.

19. A method of stimulating blooming of a flowering plant, the method comprising:
selecting a flowering plant under conditions not disposed for blooming;
feeding the flowering plant with a plant food;
discontinuing feeding the flowering plant with the plant food; and
subsequently watering the flowering plant with a solution comprising D-ribose.

20. The method of claim 19 wherein the solution of D-ribose comprises 3 grams to 7 grams of D-ribose to one gallon of water.

21. A method of treating a plant with a plant growth regulator, the method comprising watering the plant with a solution comprising 50 mg to 20 grams of D-ribose to one gallon of water, wherein the D-ribose acts as a plant growth regulator.

22. The method of claim 21 wherein the D-ribose acts as a plant growth regulator to reduce stem elongation and/or to increase branching.

23. The method of claim 21 wherein the solution of D-ribose comprises 3 grams to 7 grams of D-ribose to one gallon of water.
